(19) United States
(12) Patent Application Publication
(10) Pub. No.: US 2022/0374840 A1
(43) Pub. Date: Nov. 24, 2022

(54) SYSTEM AND METHOD FOR ARTIFICIAL INTELLIGENCE (AI) MODELING FOR VIRTUAL RECRUITING

(71) Applicant: Celential.ai Inc, Sunnyvale, CA (US)

(72) Inventor: Aiguo Dong, Los Altos, CA (US)

(21) Appl. No.: 17/747,390

(22) Filed: May 18, 2022

Related U.S. Application Data
(60) Provisional application No. 63/192,334, filed on May 24, 2021.

(51) Int. Cl. G06Q 10/10; H04L 51/10; H04L 51/046

(52) U.S. Cl. CPC G06Q 10/1053; H04L 51/10; H04L 51/046

(57) ABSTRACT

A new approach is proposed to support virtual recruiting to automatically identify qualified candidates for a hiring company via artificial intelligence (AI)—driven data collection and analysis. First, data about professionals in a field of a job position offered by a hiring company is collected from various sources over the Internet. The collected information from the various sources are then matched, merged, and analyzed to identify a set of potential candidates for the position via one or more AI models. The set of potential candidates is further assessed and scored for mutual fit between the set of potential candidates and the hiring company's description for the position to determine a set of good matching candidates for the position. Personalized electronic communications customized towards the interests of the set of identified good matching candidates are automatically generated and sent to each of the set of good matching candidates.

### CROSS-REFERENCE TO RELATED APPLICATIONS

This application claims the benefit of U.S. Provisional Patent Application No. 63/192,334, filed May 24, 2021, which is incorporated herein in its entirety by reference.

The application is related to co-pending U.S. patent application Ser. No. ______, filed______, 2021, and titled “System and Method for Artificial Intelligence (AI) —Driven Information Collection and Analysis for Virtual Recruiting,” which is incorporated herein in its entirety by reference.

### BACKGROUND

As today's economy is increasingly relying on human talent, there is fierce competition for talent in the job market. As a result, most companies are having a tough time finding enough qualified candidates to fill their critical positions, especially those highly-paid ones requiring substantial professional skills and experiences. These companies often employ recruiters to help them find candidates to fill roles on a timely basis. Unfortunately, these human recruiters generally need a good amount of time to get up to speed on new roles to be filled and average recruiters may not have a deep understanding of the domain and/or the specific roles they are trying to fill. Consequently, these recruiters frequently may not be able to identify strong candidates from weak ones and often waste a lot of time chasing the wrong candidates while missing out on the good ones. In addition, many potential candidates are gainfully employed in today's economy and are not looking for jobs. These people are commonly referred to as passive candidates, meaning that they are not actively looking for jobs but can be convinced to consider new opportunities. For many positions to be filled, companies would like to be able to identify and contact these passive candidates to hopefully convert them into warm candidates who are interested in these positions. Traditional human recruiters, however, are often ineffective at finding good passive candidates and getting them interested in the positions. While there are many recruiting software or websites that can help with recruiting effort, few of these software or websites can do a good job at matching candidates with the positions to be filled, let alone identifying good passive candidates.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support AI modeling for virtual recruiting in accordance with some embodiments.

FIG. 2 depicts an example of a talent graph for a potential candidate in the software engineering field in accordance with some embodiments.

FIG. 3 depicts an example of an automatically generated personalized electronic message to a good matching candidate in accordance with some embodiments.

FIG. 4 depicts a flowchart of an example of a process to support AI modeling for virtual recruiting in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed to support virtual recruiting to automatically identify qualified candidates for a hiring company/entity via artificial intelligence (AI)—driven data collection and analysis. First, information and/or raw data about professionals in a field of a job position offered by a hiring company is collected from various sources over the Internet. The collected information from the various sources are then matched, merged/reconciled, and analyzed to identify a set of potential candidates for the position via one or more AI models. The set of potential candidates is further assessed and scored to match mutual interest and fit between the set of potential candidates and the hiring company's description for the position to determine a set of good matching candidates for the position. Personalized electronic communications (e.g., emails or social media messages) customized towards the interests of the set of identified good matching candidates are automatically generated and sent to each of the set of good matching candidates, wherein such personalized electronic communications are intended to get the good matching candidates' attention to get in touch with and/or interview with the hiring company for the position offered.

Using AI-driven data collection and analysis, the proposed virtual recruiting approach is able to automatically identify the best matching candidates for a position based on in-depth knowledge and understanding of the potential candidates among a large pool of professionals, including those who are not actively looking for a job, in an efficient and timely manner. The proposed approach is further able to facilitate a personalized approach to communicate with and attract the best matching candidates with a higher success rates than a conventional human recruiter.

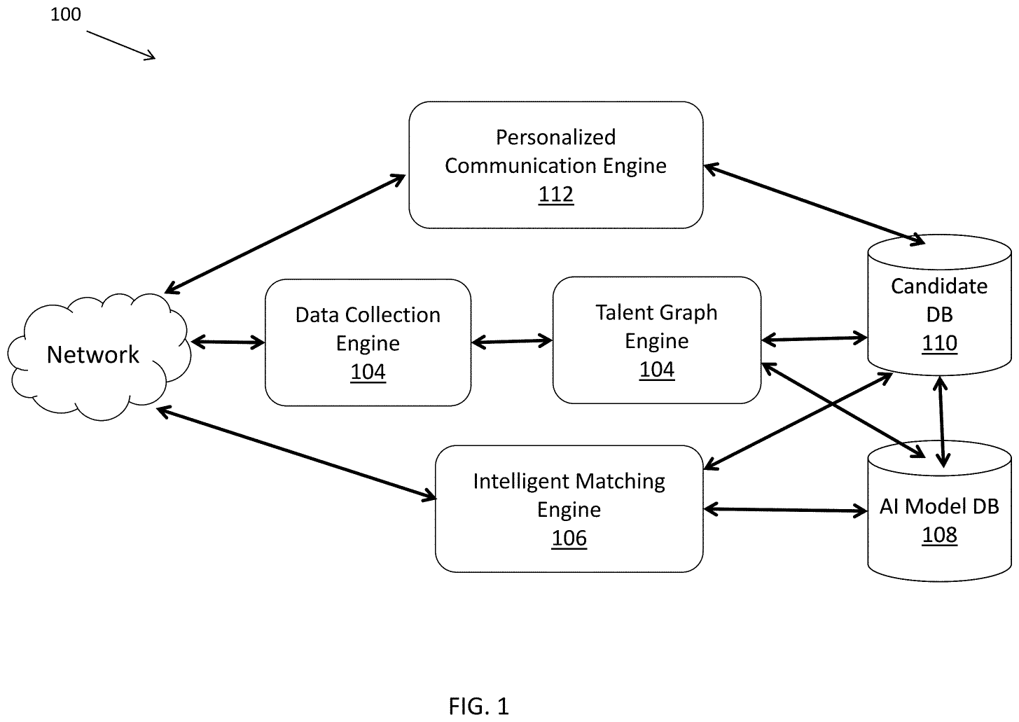

FIG. 1 depicts an example of a system diagram 100 to support AI-driven virtual recruiting. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a data collection engine 102, a talent graph engine 104, an intelligent matching engine 106, an AI model database 108, a candidate database (DB) 110, and a personalized communication engine 112. These components in the system 100 each runs on one or more computing units/appliances/devices/hosts (not shown) each with software instructions stored in a storage unit such as a non-volatile memory (also referred to as secondary memory) of the computing unit for practicing one or more processes. When the software instructions are executed, at least a subset of the software instructions is loaded into memory (also referred to as primary memory) by one of the computing units, which becomes a special purpose one for practicing the processes. The processes may also be at least partially embodied in the computing units into which computer program code is loaded and/or executed, such that, the host becomes a special purpose computing unit for practicing the processes.

In the example of FIG. 1, each computing unit can be a computing device, a communication device, a storage device, or any computing device capable of running a software component. For non-limiting examples, a computing device can be but is not limited to a server machine, a laptop PC, a desktop PC, a tablet, a Google's Android device, an iPhone, an iPad, or a voice-controlled speaker or controller. Each of the data collection engine 102, the talent graph engine 104, the intelligent matching engine 106, the AI model database 108, the candidate database 110, and the personalized communication engine 112 is associated with a communication network (not shown), which can be but is not limited to, Internet, intranet, wide area network (WAN), local area network (LAN), wireless network, Bluetooth, WiFi, and mobile communication network for internal communications among entities, components, and users of an organization. The physical connections of the communication network and the communication protocols are well known to those skilled in the art.

In the example of FIG. 1, the data collection engine 102 is configured to collect data of a plurality of professionals based on a set of key terms by crawling a plurality of data sources over the Internet. Here, the set of key terms includes but is not limited to one or more of technology field, qualification, skills, education, experiences of the professionals. In some embodiments, the plurality of data sources include but are not limited to professional networks, social networks (e.g., Facebook), horizontal websites that cover various disciplines (e.g., search engine such as Google), and vertical websites that specialize in a certain profession (e.g., Github and Stackoverflow used often by software engineers). In some embodiments, the data collection engine 102 is configured to collect data from academic or technical publications at conferences and/or journals to where the professionals publish. In some embodiments, the data collection engine 102 is configured to collect data from long-tail websites, such as personal websites where information about the professionals and/or their current employers can be found. In some embodiments, the data collection engine 102 is configured to collect data of the professionals from a specific vertical industry and/or in a specific geographical region. For a non-limiting example, the data collection engine 102 may collect data of all software engineers based in US/Canada.

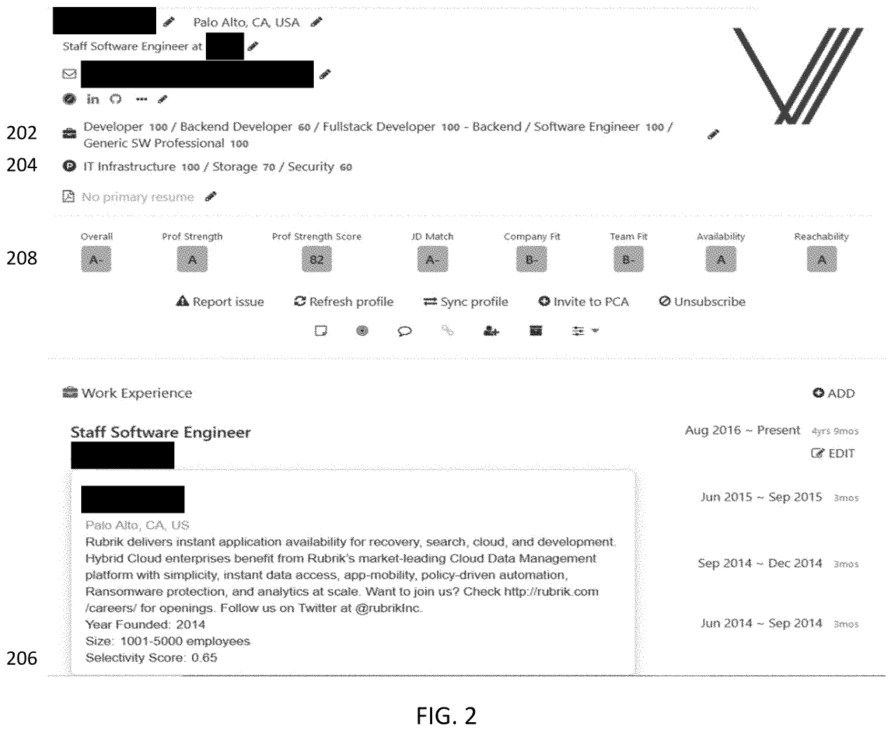

In some embodiments, the talent graph engine 104 is configured to build a talent graph for each of the plurality of professionals based on the data collected by the data collection engine 102, wherein the talent graph intelligently combines the scores on various aspects of each of the plurality of professionals' background, education, skills, past and current employment. In some embodiments, the talent graph engine 104 is configured to pre-built the talent graph for the plurality of professionals before any specific job description is received by intelligent matching engine 106. FIG. 2 depicts a non-limiting example of a talent graph for a professional in the software engineering field. As shown by the example of FIG. 2, the past positions/titles 202 held by the professional and the skills or specialized areas 204 of the professional are scored, respectively.

In some embodiments, the talent graph engine 104 is configured to generate one or more scores on professional strength of a professional based on one or more of the professional's background, the companies the professional worked for, the schools the professional went to, and other people the person worked with as reflected in the respective talent graph of the professional. Such scores on professional strength are good indications of how well the professional did and is currently doing in his/her profession. In some embodiments, the talent graph engine 104 is configured to generate a score for each company the professional has worked for in the past or is currently working at based on the company's background, age, size, revenue trajectory, funding history, product and service offerings, other people who work or worked at the company, etc. In some embodiments, the score for each of the companies is a time-series data indicating how selective the company was in hiring at a point of time, which is an indication of the professional's qualification especially in view of companies that are highly selective. As shown by the example of FIG. 2, all companies the professional has worked for are also scored for their selectivity 206, which is an indication of how selective the companies were in hiring engineers as well as the professional's overall qualification in the eyes of a third party.

In the example of FIG. 1, the talent graph engine 104 is configured to accept and to merge/reconcile the data collected by the data collection engine 102 from the plurality of different data sources with respect to each of the plurality of professionals when building the talent graph. In some embodiments, the talent graph engine 104 is configured to determine that a first profile collected from a first data source (e.g., StackOverflow) and a second profile collected from a second data source (e.g., Github) belong to the same professional by matching a set of attributes of the profiles even when it is not obvious for a human being to make such determination. Here, the set of attributes used for the matching includes but is not limited to one or more of name, geographical location, company name, profile ID, education, skills, and professional experiences. In some embodiments, the talent graph engine 104 is configured to determine that the two profiles belong to the same person based on an exact match of one or more of the set of attributes of the two profiles. In some embodiments, the talent graph engine 104 is configured to determine that the two profiles belong to the same person based on a fuzzy match of one or more of the set of attributes of the two profiles, where the talent graph engine 104 identifies that the one or more of the set of attributes are approximately similar (via, e.g., approximate string matching) even though these attributes are not exactly the same. In some embodiments, the talent graph engine 104 is configured to perform face recognition and compare the profile pictures extracted from the two profiles to determine that the two profiles belong to the same person if the key features of the faces extracted from the profile pictures are the same or substantially similar.

Once the two profiles are matched to the same person, the talent graph engine 104 is configured to merge and reconcile the data from the two profiles to establish a new profile for the professional as part of his/her talent graph if he/she does not have a profile yet or to augment an existing profile of the professional and to save the profile of the professional in the candidate database 110. In some embodiments, the talent graph engine 104 is configured to establish a new company profile or augment an existing company profile for each of the companies the professional has worked for and maintain such company profiles in the candidate database 110 in order to have a better assessment and evaluation of the potential candidates.

In some embodiments, the talent graph engine 104 is configured to train one or more AI models maintained in the AI model database 108 using the profiles of the professionals and/or their companies maintained in the candidate database 110 as well as other data necessary for the training of the one or more AI models. In some embodiments, the talent graph engine 104 is configured to train the one or more AI models using natural language processing (NLP) of the text portion of the profiles and/or computer vision (CV)/image processing of the image portion of the profiles. In some embodiments, the talent graph engine 104 is configured to train the one or more AI models via one or more of supervised learning with labeled data, semi-supervised learning with a small set of labeled data and a large set of unlabeled data, unsupervised learning with completely unlabeled data, and proprietary data-mining or inference based on domain expertise in a specific vertical field (e.g., software engineering or sales and marketing).

In some embodiments, the one or more AI models include Bidirectional Encoder Representations from Transformers (BERT) model, which is an AI model representing skills as a skill graph in which every output element from the AI model is connected to every input element of the AI model, and the weightings between the input and output elements are dynamically calculated by the talent graph engine 104 based upon the connections among these elements (e.g., related skills). In some embodiments, the one or more AI models include long short-term memory (LSTM), which is an AI model representing a recurrent neural network architecture. Unlike standard feedforward neural networks, the LSTM model has feedback connections so it can process not only single data points, but also entire sequences of data points (e.g., a set of skills or a sequence of employments) for correlation among the data points. In some embodiments, the one or more AI models include one or more conditional random fields (CRFs), which are statistical models applied in pattern recognition (e.g., face recognition) and used for structured prediction. Whereas a classifier predicts a label for a single data point without considering “neighboring” data points, CRFs can take context of associated data points (e.g., skills or employment histories) into account to make predictions. Once trained, these one or more AI models are maintained in the AI model database 108.

In the example of FIG. 1, the intelligent matching engine 106 is configured to accept a description of a job opening/position to be filled at a hiring company/entity and to extract a set of key terms from the description. In some embodiments, the intelligent matching engine 106 is configured to accept corporate data of the hiring company of the position and/or the companies where the professionals are currently employed. Such corporate data includes but is not limited to financial performance, funding, revenue (actual or estimate), sales, employee count, and product data. The intelligent matching engine 106 is then configured to identify a set of potential candidates to fill the opening position offered by the company based on the one or more AI models from the AI model database 108. In some embodiments, the one or more AI models capture the set of potential candidates' background, specialization, set of skills, the strength of the set of skills and how recently they have used the set of skills in order to predict how well the set of potential candidates' qualifications may match with the opening position. In some embodiments, the one or more AI models infer skills that one of the set of potential candidates may have based on the potential candidate's coworkers' profiles. In some embodiments, the one or more AI models infer the skills that one of the set of potential candidates may have based on technologies in use at the companies the potential candidate is currently employed or was employed in the past from the companies' profiles in the candidate database 110. In some embodiments, the one or more AI models further capture one or more key milestones/events in the set of potential candidates' past employment history (e.g., how often do they switch employment and why) and their current employment status (e.g., how long they have been with the current employer, the projects they are currently working on, and the sentiments or opinions they have expressed about these current projects, etc.).

In some embodiments, the intelligent matching engine 106 is configured to rank the set of potential candidates based on predicted mutual fit between the set of potential candidates and the hiring company's job requirements for the job opening, based on how well the set of potential candidates fit the opening, how likely the set of potential candidates are likely to be open to new job openings, and how likely the company will be able to contact them. In some embodiments, the intelligent matching engine 106 is configured to utilize the one or more AI models to score the mutual fit with a 360-degree assessment in multiple dimensions and create a single score to measure the overall fit for the job opening. Here, the multiple dimensions used to assess the mutual fit for each potential candidate include but are not limited to one or more of technical qualification, domain experience relevancy, caliber level match, similarity between the hiring company and the past employers of the potential candidate, common background/connections between the potential candidate and current team members, commute time for the potential candidate, likelihood to switch jobs by the potential candidate, compensation match, and attractiveness of the opportunity to the candidate. 208 in FIG. 2 depicts a non-limiting example of a set of scores of the potential candidate's professional strength, job description match, company fit, team fit, availability, reachability, and overall qualification/fit for the job opening. In some embodiments, the intelligent matching engine 106 is configured to also take into account the hiring company's potentially hidden preferences for the opening during ranking of the potential candidates. The intelligent matching engine 106 then determines a set of good matching candidates for the opening and saves their profiles in the candidate database 110. For a non-limiting example, from an initial set of five million data points collected by the data collection engine 102, the intelligent matching engine 106 quickly identifies 1,000 potential candidates based on their talent graphs, and then performs a deep analysis for the 1,000 potential candidates and ranks them based on the mutual fit between each of the potential candidates and the job requirement, which would lead to 100 highly qualified good matching candidates to be saved in the candidate database 110.

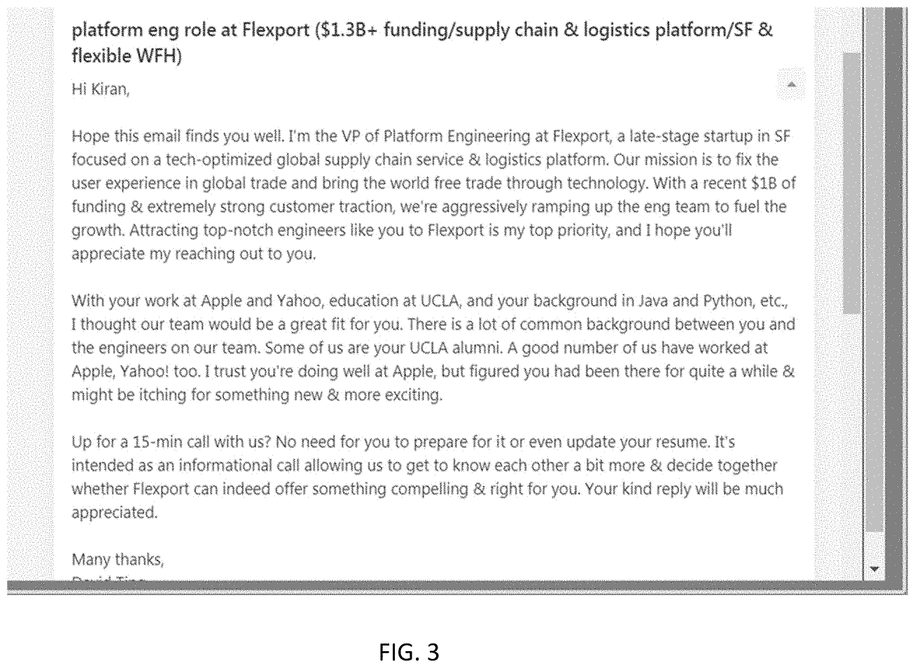

In the example of FIG. 1, the personalized communication engine 112 is configured to retrieve the profiles of the good matching candidates from the candidate database 110 and to automatically generate and send a personalized electronic message (e.g., an email) to each of the set of good matching candidates based on their profiles. FIG. 3 depicts an example of an automatically generated personalized electronic message to a good matching candidate. Here, the personalized electronic message to the each of the set of good matching candidates is customized or tailored by the personalized communication engine 112 based on one or more of the good matching candidate's background, what is relevant to the hiring company's needs, connections or common background between the good matching candidate and the hiring company's current team members. In some embodiments, the personalized communication engine 112 is configured to embed a tracking code or token inside the personalized electronic message in order to track the good matching candidate's interactions with the personalized electronic message, e.g., the personalized communication engine 112 will be notified when the good matching candidate opens and reads the personalized electronic message and/or clicks on any embedded links or content in the personalized electronic message. Based on the feedback received from the good matching candidate, the personalized communication engine 112 is configured to schedule a contact with the good matching candidate, e.g., a couple of days after the good matching candidate receives the personalized electronic message if they haven't replied yet. In some embodiments, the personalized communication engine 112 is configured to automatically process content of any replies received from the good matching candidate in response to the personalized electronic message to perform sentiment analysis or classification to identify any potential interest in the job opening by the good matching candidate. If a potential interest or a positive sentiment is identified, meaning that the good matching candidate may be potentially interested in the job opening, the personalized communication engine 112 is configured to follow up with the good matching candidate and to notify the hiring company accordingly in order to proceed to the next step.

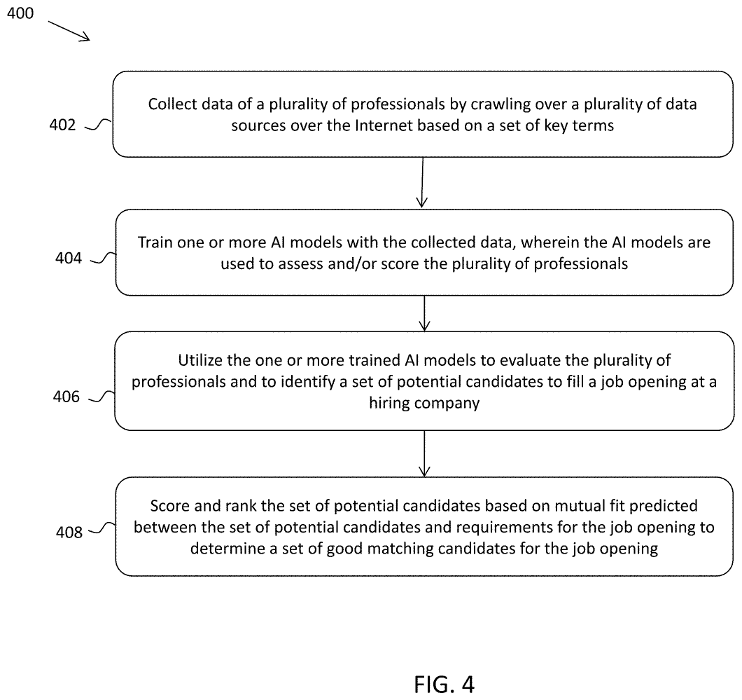

FIG. 4 depicts a flowchart 400 of an example of a process to support AI modeling for virtual recruiting. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 4, the flowchart 400 starts at block 402, where data of a plurality of professionals is collected by crawling over a plurality of data sources over the Internet based on a set of key terms. The flowchart 400 continues to block 404, where one or more AI models are trained with the collected data, wherein the AI models are used to assess and/or score the plurality of professionals. The flowchart 400 continues to block 406, where the one or more trained AI models are utilized to evaluate the plurality of professionals and to identify a set of potential candidates to fill a job opening at a hiring company. The flowchart 400 ends at block 408, where the set of potential candidates are scored and ranked based on mutual fit predicted between the set of potential candidates and the requirements for the job opening to determine a set of good matching candidates for the job opening.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

What is claimed is:

1. A system to support artificial intelligence (AI) modeling for virtual recruiting, comprising:
a data collection engine configured to collect data of a plurality of professionals by crawling over a plurality of data sources over Internet based on a set of key terms;
a talent graph engine configured to train one or more AI models with the collected data, wherein the AI models are used to assess and/or score the plurality of professionals;
an intelligent matching engine configured to
utilize the one or more trained AI models to evaluate the plurality of professionals and to identify a set of potential candidates to fill a job opening at a hiring company;
score and rank the set of potential candidates based on mutual fit predicted between the set of potential candidates and requirements for the job opening to determine a set of good matching candidates for the job opening.

2. The system of claim 1, further comprising:
a personalized communication engine configured to automatically generate and send a personalized electronic message to each of the set of good matching candidates based on his/her profile.

3. The system of claim 1, wherein:
the talent graph engine is configured to train the one or more AI models using natural language processing (NLP) of text portion of the collected data and/or image processing of the image portion of the collected data.

4. The system of claim 1, wherein:
the talent graph engine is configured to train the one or more AI models via one or more of supervised learning with labeled data, semi-supervised learning with a small set of labeled data and a large set of unlabeled data, unsupervised learning with completely unlabeled data, and proprietary data-mining or inference based on domain expertise in a specific vertical field.

5. The system of claim 1, wherein:
the one or more AI models capture one or more of background, specialization, set of skills, the strength of the set of skills of the set of potential candidates and how recently they have used the set of skills.

6. The system of claim 5, wherein:
the one or more AI models infer the skills that one of the set of potential candidates has based on the potential candidate's coworkers' profiles.

7. The system of claim 5, wherein:
the one or more AI models infer the skills that one of the potential candidates has based on technologies in use at the companies the potential candidate is currently employed or was employed in the past.

8. The system of claim 1, wherein:
the one or more AI models capture one or more key milestones or events in the past employment history and/or current employment status of the potential candidates.

9. The system of claim 1, wherein:
the one or more AI models include a Bidirectional Encoder Representations from Transformers (BERT) model representing skills as a skill graph, wherein every output element from the model is connected to every input element of the model, and wherein weightings between the input and output elements are dynamically calculated by the intelligent matching engine based upon the connections among the elements.

10. The system of claim 1, wherein:
the one or more AI models include a long short-term memory (LSTM) model, which is an AI model representing a recurrent neural network architecture configured to process an entire sequence of data points for correlation among the data points.

11. The system of claim 1, wherein:
the one or more AI models include one or more conditional random fields (CRFs) models, which are statistical models taking context of associated data points into account to make predictions for face recognition.

12. A method to support artificial intelligence (AI)—driven virtual recruiting, comprising:
collecting data of a plurality of professionals by crawling over a plurality of data sources over Internet based on a set of key terms;
merge the data collected from the plurality of different data sources that belongs to each of the plurality of professionals;
utilizing the one or more trained AI models to evaluate the plurality of professionals and to identify a set of potential candidates to fill a job opening at a hiring company;
scoring and ranking the set of potential candidates based on mutual fit predicted between the set of potential candidates and the requirements for the job opening to determine a set of good matching candidates for the job opening;

13. The method of claim 12, further comprising:
automatically generating and sending a personalized electronic message to each of the set of good matching candidates based on his/her profile.

14. The method of claim 12, further comprising:
training the one or more AI models using natural language processing (NLP) of text portion of the collected data and/or image processing of the image portion of the collected data.

15. The method of claim 12, further comprising:
training the one or more AI models via one or more of supervised learning with labeled data, semi-supervised learning with a small set of labeled data and a large set of unlabeled data, unsupervised learning with completely unlabeled data, and proprietary data-mining or inference based on domain expertise in a specific vertical field.

16. The method of claim 12, further comprising:
capturing one or more of background, specialization, set of skills, the strength of the set of skills of the set of potential candidates and how recently they have used the set of skills via the one or more AI models.

17. The method of claim 12, further comprising:
inferring the skills that one of the set of potential candidates has based on the potential candidate's coworkers' profiles via the one or more AI models.

18. The method of claim 12, further comprising:
inferring the skills that one of the potential candidates has based on technologies in use at the companies the potential candidate is currently employed or was employed in the past via the one or more AI models.

19. The method of claim 12, further comprising:
capturing one or more key milestones or events in the past employment history and/or current employment status of the potential candidates via the one or more AI models.

20. The method of claim 12, further comprising:
including in the one or more AI models a Bidirectional Encoder Representations from Transformers (BERT) model representing skills as a skill graph, wherein which every output element from the model is connected to every input element of the model, and wherein weightings between the input and output elements are dynamically calculated based upon the connections among the elements.

21. The method of claim 12, further comprising:
including in the one or more AI models a long short-term memory (LSTM) model, which is an AI model representing a recurrent neural network architecture configured to process an entire sequences of data points for correlation among the data points.

22. The method of claim 12, further comprising:
including in the one or more AI models one or more conditional random fields (CRFs) models, which are statistical models taking context of associated data points into account to make predictions for face recognition.
